(19) United States
(12) Patent Application Publication
(10) Pub. No.: US 2010/0243670 A1
(43) Pub. Date: Sep. 30, 2010

(54) METHODS AND PRODUCTS FOR REPLENISHING A POLISHING SLURRY IN A POLISHING APPARATUS

(75) Inventor: David P. Tysiac, Canandaigua, NY (US)

Correspondence Address: RANKIN, HILL & CLARK LLP, 23755 Lorain Road - Suite 200, North Olmsted, OH, 44070-2224, US

(73) Assignee: FERRO CORPORATION, Cleveland, OH (US)

(21) Appl. No.: 12/410,221

(22) Filed: Mar. 24, 2009

(51) Int. Cl. G01F 11/00; B65D 35/00

(52) U.S. Cl. 222/1; 222/107

(57) ABSTRACT

Methods and products for replenishing a polishing slurry in a chemical-mechanical polishing apparatus. A preformulated polishing slurry is packaged within a container having flexible walls. When it is time to replenish the polishing slurry in a polishing apparatus, an operator manipulates the sealed container by hand, which causes deformation of the container walls. The deformation of the container walls leads to the rapid and substantially complete resuspension of the abrasive particles into the polishing slurry. Once the abrasive particles have been sufficiently resuspended, the container having flexible walls is unsealed and the polishing slurry is poured into a slurry tank associated with the polishing apparatus.

### BACKGROUND

1. Field of Invention

The invention relates to chemical-mechanical polishing and more particularly to methods and products for replenishing a polishing slurry in a chemical-mechanical polishing apparatus.

2. Description of Related Art

The chemical-mechanical polishing (“CMP”) process is used in the manufacture of optical lenses and microelectronic devices to remove material from a workpiece such as a plastic or glass lens blank or a wafer and thereby create a very smooth, scratch-free surface. In a typical CMP process, a polishing slurry is introduced between the workpiece and a polishing pad that is pressed against the workpiece. One or both of the polishing pad and the workpiece are moved relative to the other so as to cause the polishing pad to wipe against the surface of the workpiece with the polishing slurry disposed therebetween. The polishing slurry typically comprises abrasive particles that are dispersed and suspended in a carrier fluid. The carrier fluid typically comprises one or more chemical compounds that influence the rate at which material can be physically abraded from the surface of the workpiece via the polishing pad and/or the abrasive particles.

FIG. 1 schematically illustrates a polishing apparatus 10 such as is typically used in plastic lens product polishing applications. The apparatus 10 comprises a polishing machine 20 which supports a workpiece 30 such as a plastic lens blank. The polishing machine 20 presses a polishing pad 40 into contact with a surface 50 of the workpiece 30. A polishing slurry 60 is provided between the polishing pad 40 and the surface 50 of the workpiece 30. The polishing slurry 60 is supplied to the polishing machine 20 via a supply line 70 that is in fluid communication with a slurry tank 80. A pump 90 typically conveys the polishing slurry 60 from the slurry tank 80 to the polishing machine 20 through the supply line 70.

In some applications, only one polishing machine 20 is fluidly connected to the slurry tank 80. In other applications, a plurality of polishing machines 20 are connected to the same slurry tank 80 via supply lines 70. In FIG. 1, both possibilities are illustrated by use of brackets, where reference character “n” represents a whole number equal to or greater than 1. It will be appreciated that one pump 90 or a plurality of pumps could be utilized.

The capacity of the slurry tank 80 can vary from a few liters to hundreds of liters or more. The slurry tanks 80 in many commercial plastic lens polishing applications have a capacity of from about 35 to about 120 liters of polishing slurry 60. The slurry tank 80 is typically fitted with a mixing device 100, which helps prevent abrasive particles in the polishing slurry 60 from falling out of suspension and collecting as sludge in the slurry tank 80. The mixing device 100 can be a mechanical stirrer or pump or a combination of thereof.

The slurry tank 80 typically comprises a cover 110, which can be selectively opened or closed. The cover 110, when closed, keeps unwanted matter from entering the slurry tank 80 and reduces the evaporation rate of the polishing slurry 60. The cover 110, when opened, permits an operator to replenish the polishing slurry 60 in the slurry tank 80.

A polishing slurry 60 typically comprises abrasive particles that are dispersed and suspended in a carrier fluid. The carrier fluid typically comprises one or more chemical compounds that influence the rate at which a material on the surface 50 of the workpiece 30 can be physically abraded from the surface 50 of the workpiece 30 via the polishing pad 40 and/or the abrasive particles in the polishing slurry 60.

Polishing slurries are a consumable component of the CMP process that must be periodically replenished. Polishing slurries are typically preformulated and then packaged in rigid containers for shipment to end users. When it is time to replenish the polishing slurry in a polishing apparatus, the rigid container containing the preformulated polishing slurry is vigorously shaken while sealed in order to resuspend abrasive particles that have settled within the container during storage. Alternatively, the rigid container is opened and the abrasive particles are resuspended by means of a mechanical mixing or stirring device. Once an attempt has been made to resuspend the abrasive particles that have settled during storage, the cover 110 of the slurry tank 80 is opened and the polishing slurry 60 is poured from the rigid container into a slurry tank associated with the polishing apparatus.

It can be difficult to resuspend substantially all of the abrasive particles of a polishing slurry that have settled within a rigid container by means of shaking or stirring. Accordingly, residues comprising abrasive particles that were not successfully resuspended are often retained on the walls of the rigid container after the flowable portion of the polishing slurry has been poured into the slurry tank. The retention of abrasive particles in the rigid container can upset the intended weight ratio/balances of abrasive particles in the polishing slurry. Furthermore, the container bearing the residues is typically discarded, which creates waste and disposal concerns.

### BRIEF SUMMARY

In view of the foregoing, the present invention is directed towards methods and products for replenishing a polishing slurry in a chemical-mechanical polishing apparatus that overcome the foregoing problems associated with conventional containers. In accordance with the invention, the preformulated polishing slurry is packaged within a container having flexible walls. In the preferred embodiment of the invention, the container having flexible walls comprises a pouch formed of a flexible film. When it is time to replenish the polishing slurry in a polishing apparatus, an operator manually squeezes the sealed container, which causes deformation of the container walls. The deformation of the container walls leads to the rapid and substantially complete resuspension of the abrasive particles into the polishing slurry. Once the abrasive particles have been sufficiently resuspended, the container having flexible walls is unsealed and the polishing slurry is poured into a slurry tank associated with the polishing apparatus. The present invention substantially reduces the amount of abrasive particle residue remaining within the container once the polishing slurry has been poured into the slurry tank. The present invention also substantially reduces the amount of waste.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a schematic representation of a polishing apparatus used in a CMP process.

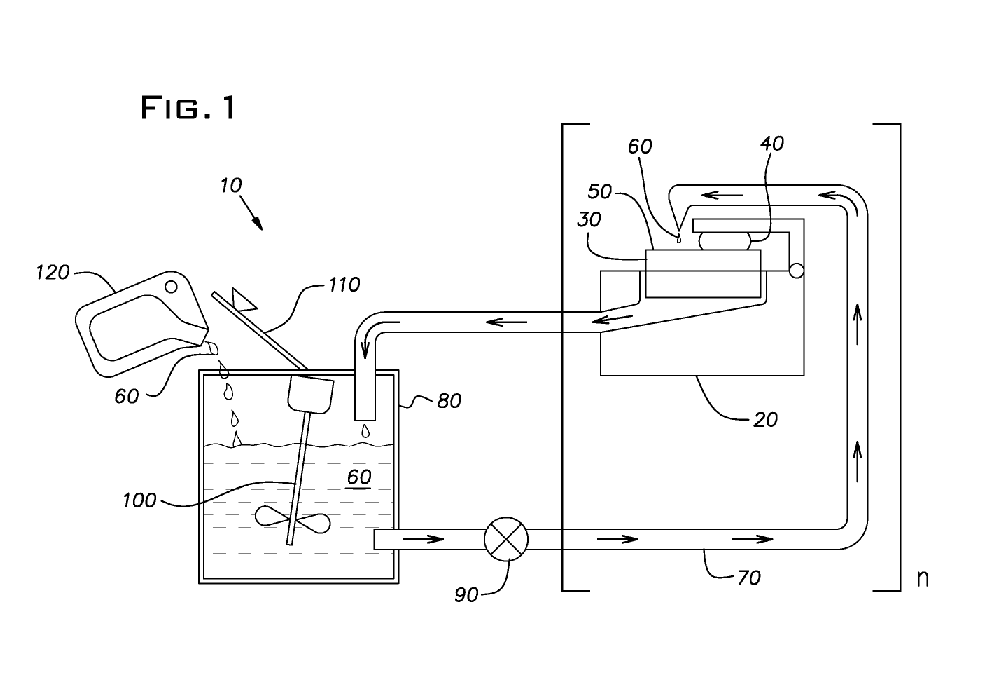

FIG. 2 is front plan view of a preferred embodiment of a sealed flexible pouch containing a polishing slurry according to the invention.

FIGS. 3-5 are front plan views showing alternative embodiments of sealed flexible pouches containing polishing slurries according to the invention.

### DETAILED DESCRIPTION

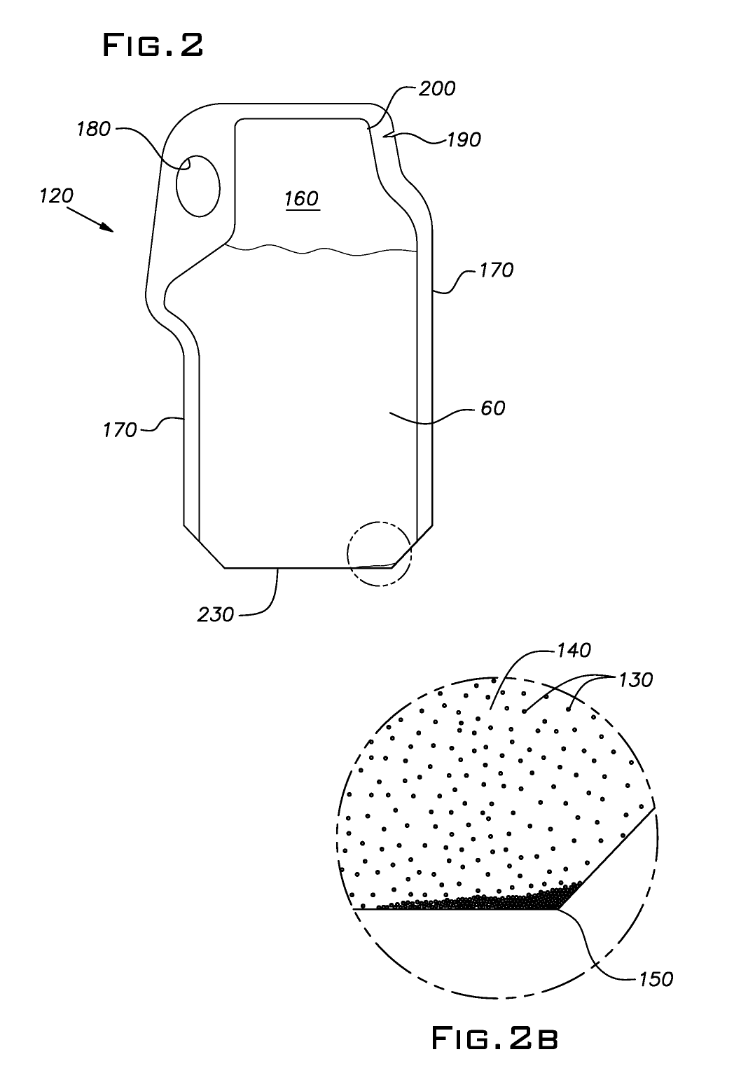

FIG. 2 shows a preferred embodiment of a sealed flexible pouch 120 containing a polishing slurry 60 in accordance with the invention. The polishing slurry 60 comprises abrasive particles 130 and a carrier liquid 140. FIG. 2b schematically illustrated an enlarged portion of the pouch 120 bounded by a circular area. The size and spacing of the abrasive particles 130 illustrated in FIG. 2b is grossly exaggerated for the purpose of illustrating the invention. Conventionally, the abrasive particles 130 will have a very small diameter, which depending upon the particular application can range from a few nanometers to as large as several hundred microns. The composition of the abrasive particles 130 will depend upon the material to be removed from the workpiece 30. Abrasives used in CMP include, for example, alumina, silica, ceria, copper oxide, iron oxide, nickel oxide, manganese oxide, silicon carbide, silicon nitride, tin oxide, titania, titanium carbide, tungsten oxide, yttria, zirconia, and combinations thereof.

The abrasive particles 130 are adapted to be suspended in the carrier liquid 14 such as, for example, water. However during shipment and storage of the pouch 120, at least a portion of the abrasive particles 130 will settle out and no longer be suspended in the carrier liquid 140. The settled abrasive particles 150 tend to collect in the corners, along the seams and/or within creases of the pouch 120. Settling is generally considered to be a time-dependent factor. Thus, the longer the polishing slurry 60 contained within the pouch 120 is at rest, the more settling of the abrasive particles that is likely to occur.

As noted above, polishing slurries are conventionally packaged, shipped and stored in containers having substantially rigid walls (e.g., buckets, plastic jugs, jars etc.). It can be very difficult to resuspend and thus redisperse the settled abrasive particles in such containers via shaking and stirring. In many cases, a portion of the abrasive particles cannot be resuspended, and remains as a residue within the container. This residue is discarded together with the container.

In accordance with the present invention, the polishing slurry 60 is contained within a sealed flexible pouch 120 having walls that are adapted to be repeatedly deformed (e.g., by squeezing or kneading using one's hands). In order to facilitate deformation of the pouch 120, at least a portion of the pouch 120 is preferably formed of a flexible polymeric film. More preferably, most of the pouch 120 is formed of a flexible polymeric film. The composition of the polymer or polymers used to form the polymeric film is not per se critical. Examples include polymeric films comprising polyethylene (e.g., linear low density polyethylene—“LLDPE”), ethylene vinyl acetate (“EVA”) polyesters and various other flexible film-forming polymers, copolymers and blends of polymers. The films can be formed of a single layer of one polymer, or can be formed as laminates of two or more layers of different film materials. It is preferable for at least a portion of the flexible polymeric film to be transparent, which allows for visual confirmation that substantially of the settled abrasive particles have been substantially resuspended via repeated deformation of the sealed flexible pouch.

In the embodiment of the invention illustrated in FIG. 2, the sealed flexible pouch 120 contains a polishing slurry 60 within a cavity 160 bounded substantially entirely by polymeric film. In the embodiment shown in FIG. 2, the pouch 120 has been formed by folding a polymeric film on itself and welding the folded polymeric film to itself along weld lines 170 so to define the cavity 160. The pouch 120 shown in FIG. 2 further comprises an opening 180 bounded entirely by weld lines, which can be used as a handle to lift the sealed flexible pouch 120. The sealed flexible pouch 120 also further comprises a notch 190, which facilitates tearing of the polymeric film at the weld line 170 to allow the polishing slurry 60 contained within the cavity 160 to be poured from the pouch 120. The notch 190 can be provided proximal to a narrowed portion 200 of the cavity, which facilitates pouring the polishing slurry 60 from the pouch 120.

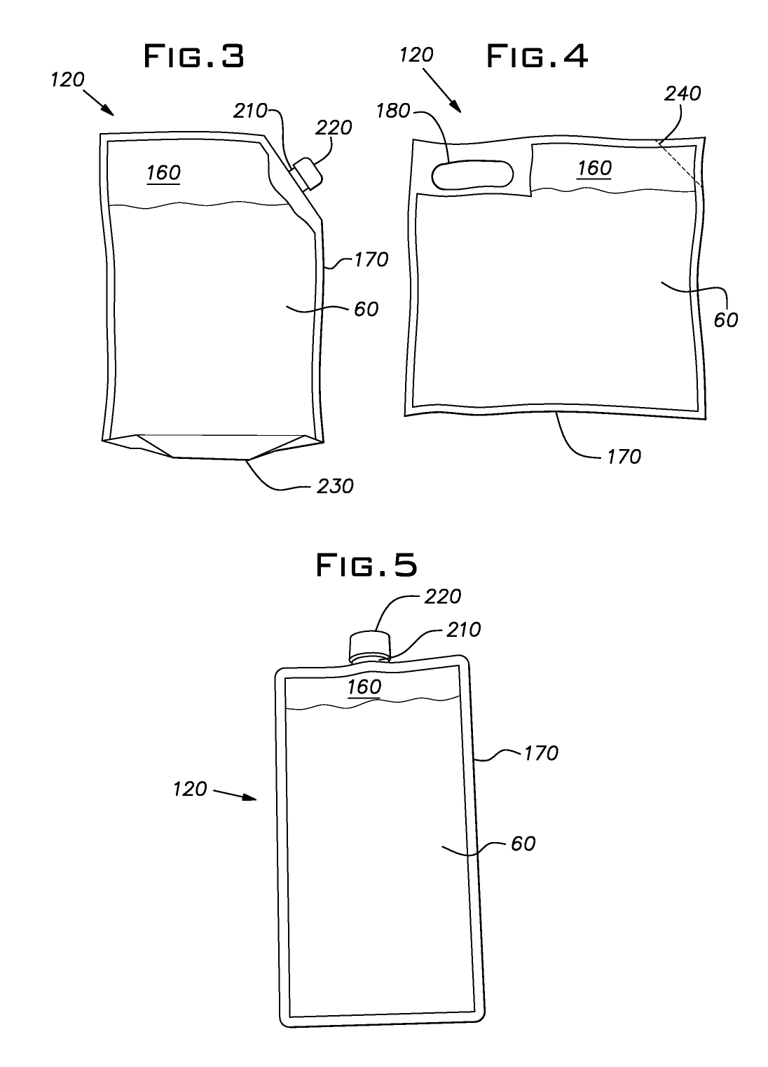

FIGS. 3-5 show alternative embodiments of pouches 120 containing polishing slurries 60 according to the invention. The same reference numbers utilized in FIG. 2 are used to identify similar structures in FIGS. 3-5. The pouch 120 shown in FIG. 3 includes a rigid spout 210, which is welded into pouch 120. The spout 210 is covered by a cap 220, which is threadingly received on the spout 210. The cap 220 can be removed to unseal the pouch 120 and then replaced to reseal the pouch 120.

The pouch 120 shown in FIG. 4 includes weld lines 170 that completely surround the cavity 160. The pouch 120 shown in FIG. 4 differs in this respect from the pouches 120 shown in FIGS. 2 and 3, which include a base portion 230 that is created by folding the flexible polymeric film and not by welding. The pouch 120 shown in FIG. 4 also does not include a spout or notch. Instead, the pouch 120 shown in FIG. 4 is provided with indicia 240, which indicates where the pouch 120 should be cut or sliced in order to allow for the polishing slurry 60 to be poured from the cavity 160. The pouch 120 shown in FIG. 4 also includes an opening 180 bounded by weld lines 170, which can serve as a handle.

The pouch 120 shown in FIG. 5 includes a spout 210 and a cap 220. Furthermore, the pouch 120 shown in FIG. 5 includes a cavity 160 that is bounded entirely by weld lines 170, except for the portion containing the spout 210. It will be appreciated that there are literally unlimited configurations (size, handles, spouts, closures, markings for volume, shapes, stand-up, pillows, labels, color, etc.) of pouches that can be utilized in accordance with the invention.

The cavity 160 of a sealed flexible pouch 120 preferably contains more than 1 liter but less than 10 liters of the polishing slurry 60. It is preferable for the cavity 160 not to be entirely filled to capacity with the polishing slurry 60. This allows the walls of the pouch 120 to be deformed by squeezing or kneading, which causes the polishing slurry 60 within the cavity to mix and become homogeneous. This also helps dislodge settled particles 150, which can more easily become resuspended in the carrier liquid 140. For ease of handling, pouches 120 containing from about 1.0 to about 3.0, or most preferably about 1.9 liters, are preferred.

The pouches 120 can be pre-manufactured and simply filled with preformulated polishing slurry 60 and sealed. Alternatively, the pouches 120 can be formed immediately prior to being filled with a polishing slurry 60. The pouches 120 can be filled using rotary or in-line filling machines, which are well know. Alternatively, the pouches 120 can be filled manually and sealed using a heated platen or RF welding equipment.

As noted, the sealed flexible pouches advantageously allow settled particles to be resuspended in the carrier liquid by squeezing, kneading or tilting the pouch back and forth. The manipulation or massaging of the pouch loosens the settled particles and thoroughly mixes the polishing slurry to form a substantially homogeneous mixture, which can then be easily poured into the slurry tank of a polishing apparatus. Little to no residue is left behind in the pouch, which is a significant improvement as compared to the use of conventional containers having rigid walls. After the polishing slurry has been poured from the pouch, the pouch can be discarded.

Pouches containing polishing slurries according to the invention are substantially more environmentally friendly than conventional polishing containers having rigid walls. They take up less warehouse/storage space. They produce less waste volume at the time of disposal. They reduce shipping costs due to weight reductions. They can be formed using <40% of the polymer necessary to form convention rigid containers.

In addition, they provide advantages to the end user. The pouches are easy to handle during the filling operation. Substantially all of the abrasive particles are resuspended, leaving virtually no residue in the pouch after the filling operation. This preserves the desired balance or ratio of abrasive particles to carrier liquid.

Thus, the present invention provides a method for replenishing a polishing slurry in a chemical-mechanical polishing apparatus having a slurry tank. The method comprises:
providing a sealed flexible pouch containing a polishing slurry comprising abrasive particles and a carrier liquid, wherein the abrasive particles are adapted to be suspended in the carrier liquid but at least a portion of the abrasive particles are not suspended in the carrier liquid;
repeatedly deforming the sealed flexible pouch for a time sufficient to suspend substantially all of the abrasive particles in the carrier fluid;

unsealing the repeatedly deformed flexible pouch; and

pouring at least a portion of the polishing slurry from the unsealed flexible pouch into the slurry tank of the chemical-mechanical polishing apparatus.

The repeatedly deforming step can be performed manually by repeatedly squeezing and releasing less than the entire sealed flexible pouch in one's hands so as to cause the polishing slurry contained in the cavity of the pouch to pulse back and forth between squeezes. The contents of the pouch can also be mixed by repeatedly tilting the sealed flexible container back and forth to thoroughly mix the polishing slurry contained therein. Automatic mixing equipment (shakers etc.) and sonic devices can also be utilized, if desired.

In a preferred application, the polishing slurry dispensed between a polishing pad and a blank used to form a plastic optical lens. In such applications, a central slurry tank (also known in the art as a “process tank”) is connected through distribution lines to a plurality of polishing apparatus. When the polishing slurry volume in the slurry tank drops to a predetermined level, the tank volume can be replenished in accordance with the method of the invention.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

What is claimed is:

1. A method for replenishing a polishing slurry in a chemical-mechanical polishing apparatus having a slurry tank, the method comprising:
providing a sealed flexible pouch containing a polishing slurry comprising abrasive particles and a carrier liquid, wherein the abrasive particles are adapted to be suspended in the carrier liquid but at least a portion of the abrasive particles are not suspended in the carrier liquid;
repeatedly deforming the sealed flexible pouch for a time sufficient to suspend substantially all of the abrasive particles in the carrier fluid;
unsealing the repeatedly deformed flexible pouch; and
pouring at least a portion of the polishing slurry from the unsealed flexible pouch into the slurry tank of the chemical-mechanical polishing apparatus.

2. The method according to claim 1 wherein at least a portion of the sealed flexible pouch is formed of flexible polymeric film.

3. The method according to claim 2 wherein at least a portion of the flexible polymeric film is transparent.

4. The method according to claim 2 wherein the flexible polymeric film comprises polyethylene.

5. The method according to claim 1 wherein the sealed flexible pouch comprises a spout.

6. The method according to claim 1 wherein the flexible pouch is resealable.

7. The method according to claim 6 further comprising resealing the flexible pouch.

8. The method according to claim 1 wherein the flexible pouch cannot be resealed after it is unsealed.

9. The method according to claim 1 wherein the sealed flexible pouch contains more than 1 liter but less than 10 liters of the polishing slurry.

10. The method according to claim 1 wherein the repeatedly deforming step is performed manually and comprises repeatedly squeezing and releasing less than the entire sealed flexible pouch to as to cause the polishing slurry contained therein to pulse back and forth between squeezes.

11. The method according to claim 1 wherein the repeatedly deforming step is performed manually and comprises repeatedly tilting the sealed flexible container back and forth to thoroughly mix the polishing slurry contained therein.

12. The method according to claim 1 wherein the polishing apparatus is adapted to polish plastic lens products.

13. A sealed flexible pouch containing a polishing slurry comprising abrasive particles and a carrier liquid, wherein all of the abrasive particles are adapted to be suspended in the carrier liquid but at least a portion of the abrasive particles are not suspended in the carrier liquid, and wherein the sealed flexible pouch is adapted to be repeatedly deformed so as to suspend substantially all of the abrasive particles in the carrier fluid.

14. The sealed flexible pouch according to claim 13 wherein at least a portion of the sealed flexible pouch is formed of flexible polymeric film.

15. The sealed flexible pouch according to claim 14 wherein at least a portion of the flexible polymeric film is transparent.

16. The sealed flexible pouch according to claim 14 wherein the flexible polymeric film comprises polyethylene.

17. The sealed flexible pouch according to claim 13 wherein the sealed flexible pouch further comprises a spout.

18. The sealed flexible pouch according to claim 13 wherein the flexible pouch is adapted to be unsealed and resealed.

19. The sealed flexible pouch according to claim 13 wherein the flexible pouch is not adapted to be resealed after it is unsealed.

20. The sealed flexible pouch according to claim 13 wherein the sealed flexible pouch contains more than 1 liter but less than 10 liters of the polishing slurry.
